(19) United States
(12) Patent Application Publication
(10) Pub. No.: US 2002/0113776 A1
(43) Pub. Date: Aug. 22, 2002

(54) Trackball mouse

(76) Inventor: Ran Meriaz, Warner-Robins, GA (US)

Correspondence Address: WILLIAM P. SMITH, 223 FOXBURG DRIVE, PITTSBURGH, PA, 15205, US

(21) Appl. No.: 09/790,354

(22) Filed: Feb. 21, 2001

(51) Int. Cl. G09G 5/08

(52) U.S. Cl. 345/167

(57) ABSTRACT

What is disclosed is a trackball mouse for controlling cursor movement on a computer monitor screen. The mouse is made of a contoured hollow housing having a curvaceous rounded top, a flat bottom, and top and bottom apertures. A spherical trackball is rotatably, movably mounted through said top aperture. At least a portion of said trackball protruding through the top aperture to allow operation of the trackball with a person's finger. A spherical bottom ball is rotatably movably mounted through the bottom aperture. At least a portion of the bottom ball protruding through the bottom aperture. A cable is connected to a computer input port for transmission of electrical signals to a central processing unit. The trackball is manipulable by a person's finger placed upon the trackball, and freely rotatable about 360° of two dimensional axes to translate movement of a cursor on a computer screen. Also, the bottom ball is manipulable by movement of the trackball housing using a person's hand to apply downward pressure on the bottom ball against a flat surface to create frictional rotational movement about 360° of two dimensional axes to translate movement of a cursor on a computer screen. Manipulation of either said trackball or said bottom ball is effective to direct movement of a cursor on a computer monitor screen for signal inputs to the central processing unit. Optionally an optical sensor may be substituted for the bottom ball.

The title of the invention is Trackball Mouse. This invention was disclosed in Disclosure Document No. 451702 filed Feb. 22, 1999.

### FIELD OF THE INVENTION

This invention relates to a computer mouse input device, and more particularly to a combined trackball and roller ball or optical mouse.

### BACKGROUND OF THE INVENTION

When moving computer screen cursor with a mouse long distances, a standard mouse is effective; yet when the movement is smaller and more precise, for activities such engineering drawing or complex web page designs, a trackball provides added accuracy and control. Also, when frequently moving the mouse across the screen, a trackball often proves tiring and cumbersome, and therefore a standard mouse is the better option.

### SUMMARY OF THE INVENTION

The instant invention combines the advantages of a precise, smaller trackball for detailed computer work, with the greater cursor movements capable of a standard, bottom roller ball mouse. Alternatively, an optical mouse can be used in place of the bottom roller ball mouse.

It is an object of the present invention to provide a user-friendly mouse device which gives the computer operator a choice of methods of controlling the cursor on a computer monitor screen, without having to disconnect and reconnect input devices.

What is disclosed is a trackball mouse for controlling cursor movement on a computer monitor screen. The mouse is made of a contoured hollow housing having a curvaceous rounded top, a flat bottom, and top and bottom apertures. A spherical trackball is rotatably, movably mounted through said top aperture. At least a portion of said trackball protruding through the top aperture to allow operation of the trackball with a person's finger. A spherical bottom ball is rotatably movably mounted through the bottom aperture. At least a portion of the bottom ball protruding through the bottom aperture.

A cable is connected to a computer input port for transmission of electrical signals to a central processing unit. The trackball is manipulable by a person's finger placed upon the trackball, and freely rotatable about 360° of two dimensional axes to translate movement of a cursor on a computer screen. Also, the bottom ball is manipulable by movement of the trackball housing using a person's hand to apply downward pressure on the bottom ball against a flat surface to create frictional rotational movement about 360° of two dimensional axes to translate movement of a cursor on a computer screen. Manipulation of either said trackball or said bottom ball is effective to direct movement of a cursor on a computer monitor screen for signal inputs to the central processing unit.

In an alternative embodiment, an optical sensor is positioned inside said bottom aperture and directed downwardly towards a flat surface, said sensor having capability to sense two dimensional movement in 360° of two axes. The optical sensor replaces the bottom ball of the alternate embodiment.

### DESCRIPTION OF THE DRAWINGS

FIG. 1 is an isometric view of the trackball mouse taken from above;

FIG. 2 is an isometric view of one embodiment taken from the bottom, showing a spherical bottom ball protruding downwardly.

FIG. 3 is an isometric view of an alternate embodiment of the invention illustrating an optical sensor in the bottom of the device.

### DETAILED DESCRIPTION OF THE INVENTION

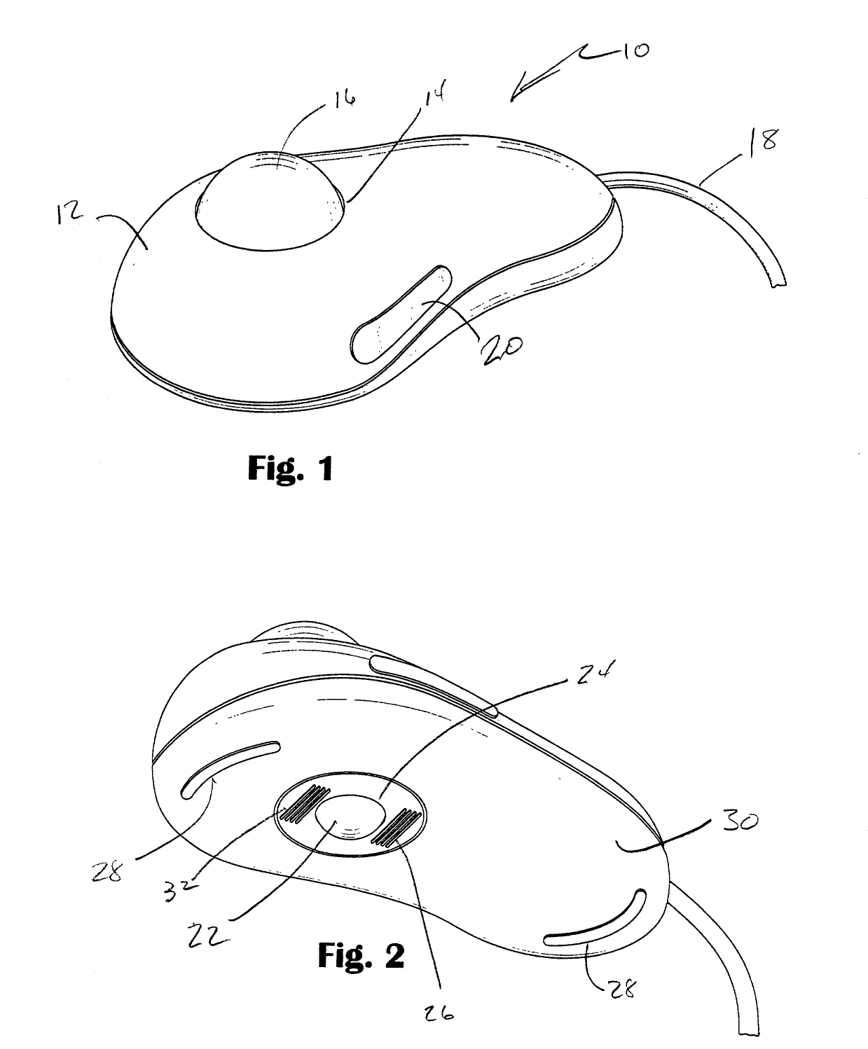

Referring first to FIG. 1, a trackball mouse is generally designated as 10. Housing 12 is a contoured, hollow shell shaped ergonomically to adapt to an average person's hand. Aperture 14 in the top of housing 12 accommodates spherical trackball 16 placed inside the aperture 14 and penetrating at least partially through the top of housing 12. Cable 18 is connected through a rear opening in the housing 12 to internally mounted x-y coordinate sensors, with multiple conductors as required to translate input signals to a computer's central processing unit (CPU). Pushbutton 20 is a click-able electrical switch which enables the user to enter discrete signals through the onoff operation of the switch.

Referring next to FIG. 2, bottom ball 22 provides the traditional mouse movement translator. Aperture 24 in escutcheon plate 32 is adapted to receive spherical bottom ball 22, and permit the ball 22 to protrude downwardly from bottom portion 30, so that ball 22 is in contact with the flat surface (not shown), such as a desktop or table, and therefore rolls or rotates when housing is moved over the flat surface. An internal transducer senses the rolling movement and translates the movement of ball 22 into x-y coordinates and conveys them to the CPU, which assigns the signal to cursor movements on the computer screen. Ribs 26 on escutcheon plate 32 provide protection to ball 22 by wiping away dust and dirt particles present on the desk surface. Pads 28 extend down from bottom portion 30, to reduce drag when moving the mouse housing 12 across a flat surface.

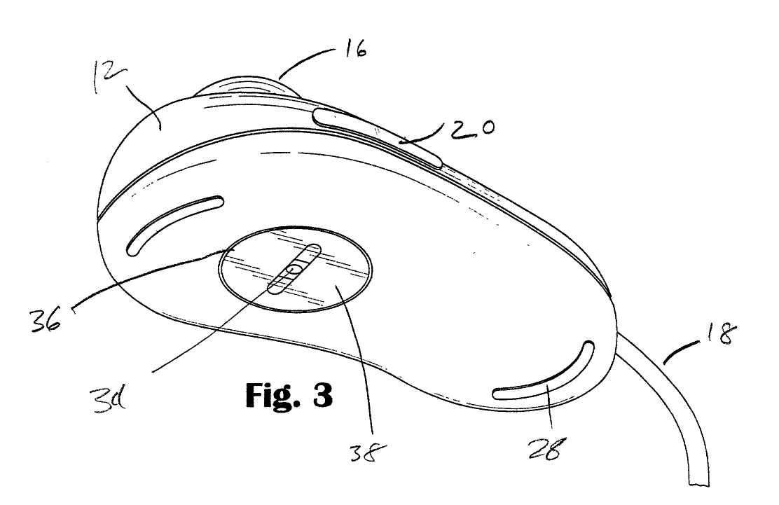

Referring next to FIG. 3, an alternative embodiment is shown in which the bottom ball 32 of FIG. 2 is replaced by an optical sensor 34. The optical sensor senses planar coordinate movement of the mouse housing 12 through an aperture 36. Lens 38 is a clear plastic disk through which light passes, so that sensor 34 can detect surface movement below mouse housing 12.

In either embodiment, the person operating the mouse typically has one hand resting on top of the housing 12. An index finger is conveniently positioned to reach the trackball 16 on the top of housing 12. If a user desires a delicate, detailed movement of the computer cursor, he or she can rotate trackball 16 with a finger. If on the other hand, a user prefers to communicate large, sweeping movements, for example, across the entire width of the screen, or simply for less detailed or accurate movement, he or she optionally may push the mouse housing 12 across a flat surface.

Switch 20 may be used to select screen options by clicking when the cursor reaches a desired position on the screen. Alternatively the switch may be used to select one or the other movement means of the mouse. A second switch may also be provided on the opposing side of housing 12 to provide further selectivity.

According to the provisions of patent statutes, I have explained the principle, preferred construction and mode of operation of my invention and have illustrated and described what I now consider to represent its best embodiments. However, it should be understood that within the scope of the appended claims, the invention may be practiced otherwise and as specifically illustrated and described.

I claim:

1. A trackball mouse for controlling cursor movement on a computer monitor screen comprising:
a contoured hollow housing having a curvaceous rounded top, a flat bottom, and top and bottom apertures;
a spherical trackball rotatably movably mounted through said top aperture; with at least a portion of said trackball protruding through the top aperture;
a spherical bottom ball rotatably movably mounted through said bottom aperture, with at least a portion of said trackball protruding through the bottom aperture;
a cable connected to a computer input port for transmission of electrical signals to a central processing unit;
such that said trackball is manipulable by a person's finger placed upon the trackball, said trackball being freely rotatable about 360° of two dimensional axes to translate movement of a cursor on a computer screen;
and such that said bottom ball is manipulable by movement of the trackball housing using a person's hand to apply downward pressure on said bottom ball against a flat surface to create frictional rotational movement about 360° of two dimensional axes to translate movement of a cursor on a computer screen; and
manipulation of either said trackball or said bottom ball is effective to direct movement of a cursor on a computer monitor screen for signal inputs to the central processing unit.

2. A trackball mouse for controlling cursor movement on a computer monitor screen comprising:
a contoured hollow housing having a curvaceous rounded top, a flat bottom, and top and bottom apertures;
a spherical trackball rotatably movably mounted through said top aperture; with at least a portion of said trackball protruding through the top aperture;
an optical sensor positioned inside said bottom aperture and directed downwardly towards a flat surface, said sensor having capability to sense two dimensional movement in 360° of two axes,
a cable connected to a computer input port for transmission of electrical signals to a central processing unit;
such that said trackball is manipulable by a person's finger placed upon the trackball, said trackball being freely rotatable about 360° of two dimensional axes to translate movement of a cursor on a computer screen;
and such that said optical sensor is manipulable by movement of the trackball housing using a person's hand to direct two-dimensional movement about 360° of two dimensional axes to translate movement of a cursor on a computer screen; and
manipulation of either said trackball or said optical sensor is effective to direct movement of a cursor on a computer monitor screen for signal inputs to the central processing unit.

3. The trackball mouse as set forth in claim 1 above, wherein also comprising means for communicating a selective signal, wherein said means is a pushbutton switch operable by applying pressure and alternately closing and opening said switch.

4. The trackball mouse as set forth in claim 2 above, wherein also comprising means for communicating a selective signal, wherein said means is a pushbutton switch operable by applying pressure and alternately closing and opening said switch.
